(19) United States
(12) Patent Application Publication
(10) Pub. No.: US 2006/0270420 A1
(43) Pub. Date: Nov. 30, 2006

(54) Method and apparatus for providing a geo-location indicator in response to a wake-up request

(76) Inventor: Cameron Brock, Beverly Hills, CA (US)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 11/368,362

(22) Filed: Mar. 2, 2006

Related U.S. Application Data
(60) Provisional application No. 60/658,422, filed on Mar. 3, 2005.

(51) Int. Cl. H04Q 7/20

(52) U.S. Cl. 455/456.2

(57) ABSTRACT

A method and an embodiment thereof for providing a two-location position report by first receiving a wake-up signal for a geo-tracking device. A geo-tracking receiver is enabled according to the wake-up signal. Two-location signals are that received in the enabled geo-tracking device. A two-location report is then generated according to the received geo-location signals. A feedback device is then enabled. The geo-location report is then conveyed to the feedback device.

### RELATED APPLICATIONS

The present application is related to a provisional application Ser. No. 60/658,422 filed on Mar. 3, 2005, entitled “METHOD AND APPARATUS FOR PROVIDING A GEO-LOCATION INDICATOR IN RESPONSE TO A WAKE-UP REQUEST”, by Brock, currently pending, for which the priority date for this application is hereby claimed.

### BACKGROUND

There are now many different ways to track people, animals and various assets. With the introduction of low-cost geo-positioning receivers, very precise geo-location can be accomplished using satellite positioning systems. The Global Positioning System is just one of many different satellite systems that can be used to determine geo-location. One important aspect of these satellite positioning systems is that a geo-position can be determined merely by passive monitoring of the signals emanating from several satellites. Because a geo-positioning receiver does not need to transmit anything up to a constellation of satellites, the geo-positioning receiver can be manufactured as an exceptionally low-powered single-chip apparatus.

Even though a modern geo-positioning receiver is both low-power and low-cost, there are still fundamental problems in using this technology in tracking applications. First, the receiver can not, in and of itself, convey a geo-location back to a tracking facility. In other words, there must be some means of conveying the geo-location of a person, an animal or an asset back to the tracking facility. One solution to this problem is that of combining a cellular telephone circuit with a geo-location receiver. Voilá, a tracking apparatus is born. This type of tracking apparatus is still not the ideal solution to many tracking applications. One reason is that the cellular telephone circuit, in order to interact with a cellular telephone system, ends up consuming quite a bit of power. Although the amount of power that a combination geo-location receiver and cellular telephone circuit does not pose a great problem in some application, it is simply prohibitive in most tracking applications.

The amount of power that a tracking apparatus uses is not a problem when high-value assets need to be tracked. For example, trucks and cargo containers can be equipped with enough battery reserve to run for extended periods of time. When these types of assets are further equipped with a solar-based battery charger, the tracking apparatus can operate indefinitely.

The amount of power that a tracking apparatus uses becomes especially problematic when tracking people or animals. It is burdensome, to say the least, to strap a large battery to a person or to an animal. Even more cumbersome is the need to either recharge or replace the battery on a regular basis. This, though, is required because the cellular telephone circuit that is used to convey a geo-location back to the tracking facility can easily drain a moderately sized battery in a few days.

There has simply been no way to avoid this type of power consumption because the cellular telephone circuit needs to be energized on a continuous basis. This is because the cellular telephone circuit is typically used to request a geo-location from the tracking apparatus. Once the request for geo-location is received by the cellular telephone circuit, the geo-location receiver is commanded to determine its geo-location. The determined geo-location is then conveyed back to the tracking facility using the cellular telephone circuit. There is simply no way to request a geo-location from the tracking apparatus unless the cellular telephone circuit is constantly operating and using electrical power. And, because of the nature of cellular communication systems, the cellular telephone circuit operates in a transmit mode in order to log in with a cellular base station. This only increases the amount of operating power that is required to operate the cellular telephone circuit.

### SUMMARY

A method and an embodiment thereof for providing a two-location position report by first receiving a wake-up signal for a geo-tracking device. A geo-tracking receiver is enabled according to the wake-up signal. Two-location signals are that received in the enabled geo-tracking device. A two-location report is then generated according to the received geo-location signals. A feedback device is then enabled. The geo-location report is then conveyed to the feedback device.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for providing a geo-location report;

FIG. 2 is a flow diagram that depicts one alternative method for receiving a wakeup signal;

FIG. 3 is a flow diagram that depicts one alternative method for monitoring for a unidirectional signal;

FIG. 4 is a flow diagram that depicts alternative example methods for extracting a message from a unidirectional signal;

FIG. 5 is a flow diagram that depicts one alternative method for enabling a geo-location receiver;

FIG. 6 is a flow diagram that depicts one alternative method for enabling a feedback device;

FIG. 7 is a flow diagram that depicts yet another variation of the present method for enabling a feedback device;

FIG. 8 is a flow diagram that depicts alternative example methods for enabling a cellular telephone interface circuit;

FIG. 9 is a flow diagram that depicts one alternative method for providing a geo-location report;

FIG. 10 is a flow diagram that depicts an alternative method for providing a geo-location report in an abduction situation;

FIG. 11 is a flow diagram that depicts one alternative variation for providing a utility function in addition to a geo-location position report;

FIG. 12 is a block diagram that depicts one example embodiment of a geo-location reporting apparatus;

FIG. 13 is a block diagram that depicts one example embodiment of a wakeup receiver;

FIG. 13A is a block diagram depicts one example embodiment of a feedback device;

FIG. 13B is a block diagram depicts another example embodiment of a feedback device; and

FIG. 14 is a block diagram depicts one alternative example embodiment of a geo-location reporting apparatus that includes a utility function.

### DETAILED DESCRIPTION

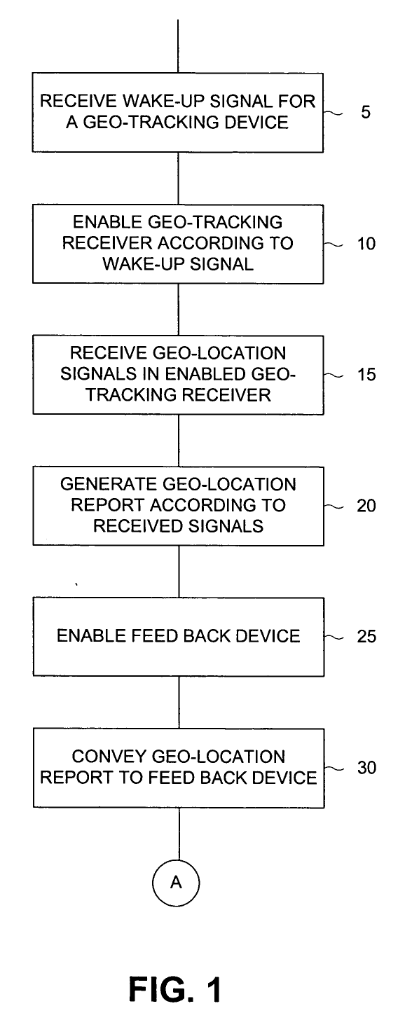

FIG. 1 is a flow diagram that depicts one example method for providing a geo-location report. According to this example method, a geo-location report is provided by receiving a wakeup signal for a geo-tracking device (step 5). Once the wakeup signal is received, a geo-tracking receiver included in the geo-tracking device is enabled (step 10). Once the geo-location receiver is enabled, geo-location signals are received in the receiver (step 15). A geo-location report is then generated according to the received geo-location signals (step 20). A feedback device is then the enabled (step 25). The generated geo-location report is then conveyed to the feedback device (step 30). It should be appreciated that, according to this example method, the geo-location report is conveyed to a distal processing center by the feedback device.

In contrast with known art, the present method provides for receiving a wakeup signal without the need to interact with an external communications system. For example, one prior art method provides for receiving a query directive by means of a cellular telephone system. In response to the query directive, one prior art method provides for enabling a geo-location receiver and performing a geo-location process, which includes receiving a plurality of geo-location signals and then generating a position report according to the received signals. The resulting geo-location position report is then conveyed to a distal processing center using the same cellular telephone interface circuit included in a geo-location tracking device that is used to receive the query directive.

When compared to the present method, the present method does not require interaction with a cellular telephone system. It should be appreciated that a cellular telephone interface circuit that is included in a prior art geo-location tracking device is required to interact with a cellular telephone system on a continuous basis. A continuous interaction with a cellular telephone system requires substantial power, which can quickly deplete a power source (e.g. a battery) when a geo-location tracking device is used in a mobile mode (i.e. without a tethered power source).

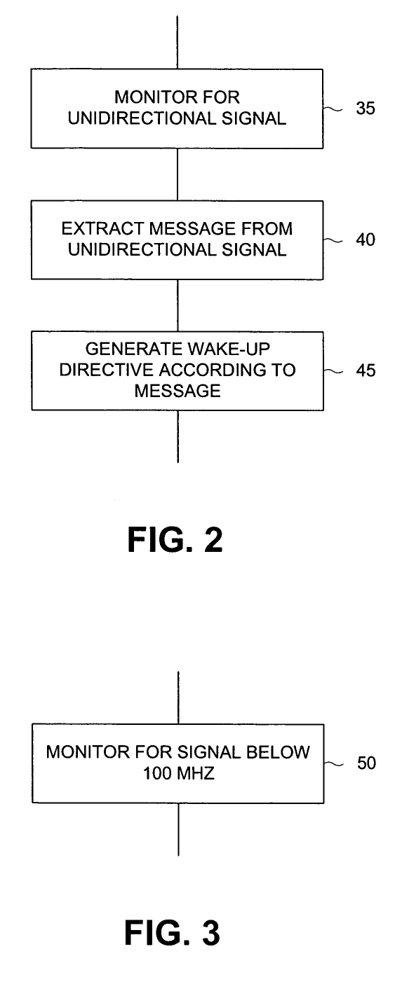

FIG. 2 is a flow diagram that depicts one alternative method for receiving a wakeup signal. According to this alternative method, a wakeup signal is received by monitoring for a unidirectional signal (step 35). As heretofore described, prior art methods for providing a geo-location position report have relied on cellular telephone systems and other similar wireless communications systems that require a constant interaction with a base system (or distal processing center). When using a cellular telephone system, a cellular telephone interface circuit typically requires constant power. This is because the cellular telephone interface circuit needs to interact with the cellular telephone system in order to be able to receive a query directive from a distal processing center. Not to dwell on the prior art, but the power required to operate a cellular telephone interface circuit can quickly drain the capacity of a typical battery, which is used to operate a geo-location tracking device in a mobile manner. Once a unidirectional signal is received, a message is extracted from the unidirectional signal (step 40). A query directive is then generated according to the extracted message (step 45).

FIG. 3 is a flow diagram that depicts one alternative method for monitoring for a unidirectional signal. According to this alternative method, monitoring for a unidirectional signal is accomplished by monitoring for a signal that is less than 100 MHz in frequency (step 50). It should be appreciated that, according to this variation of the present method, monitoring for a lower frequency signal (i.e. below 100 MHz) a lower power receiver can be implemented. As such, a receiver known as a direct-sampling receiver can be used in order to monitor for a signal that is less than 100 MHz.

Again in contrast with the prior art, a direct-sampling receiver implements a receiver function with a minimal amount of analog front-end processing circuitry. A radio frequency signal is processed by the minimal analog front-end circuitry and, as immediately practical after such analog processing, is converted into a digital data stream. The digital data stream is then subjected to digital signal processing techniques in order to receive a signal and to extract a message there from.

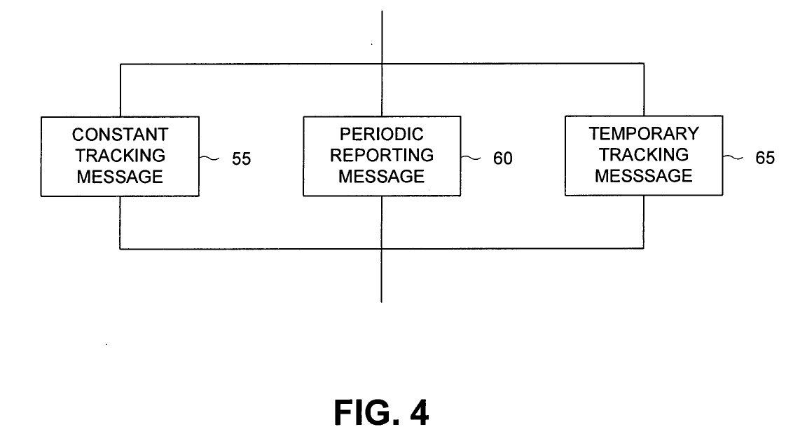

FIG. 4 is a flow diagram that depicts alternative example methods for extracting a message from a unidirectional signal. According to one variation of the present method, a message is extracted from a unidirectional signal by extracting a constant-tracking message (step 55). It should be appreciated that, according to this example variation of the present method, a geo-location tracking device will respond to a constant-tracking message by providing a continuous stream of geo-location reports to a distal processing center.

According to yet another example variation of the present method, a message is extracted from a unidirectional signal by extracting a periodic-reporting message (step 60). It should be appreciated that, according to this variation of the present method, a geo-location tracking device will respond to a periodic-reporting message by providing geo-location reports to a distal processing center on a periodic basis (e.g. once every 10 minutes).

According to yet another example variation of the present method, a message is extracted from a unidirectional signal by extracting a temporary-tracking message from the unidirectional signal (step 65). It should also be appreciated that, according to this example variation of the present method, a geo-location tracking device will respond to a temporary-tracking message by providing a pre-established quantity of geo-location reports to a distal processing center over a pre-established period of time. For example, one variation of the present method provides that a geo-location tracking device will provide a 10 geo-location position reports to a distal processing center over a period of 10 minutes, one per minute. Again, this is merely an example and is not intended to limit the scope of the claims appended hereto.

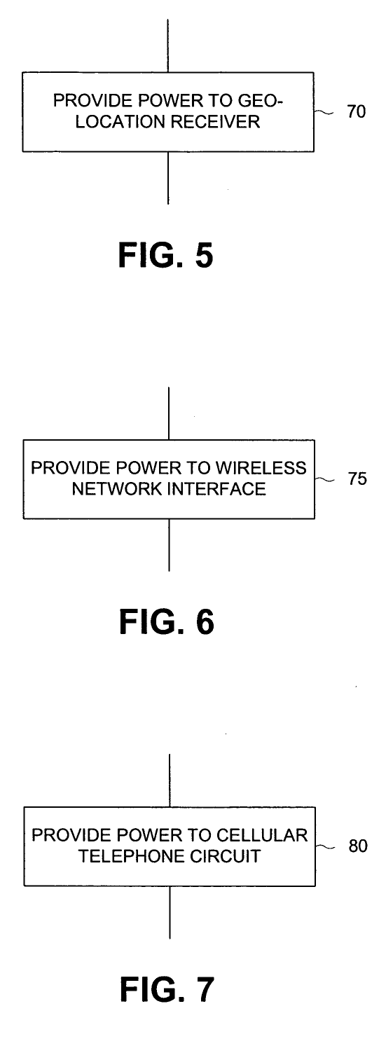

FIG. 5 is a flow diagram that depicts one alternative method for enabling a geo-location receiver. According to this example variation of the present method, a geo-location receiver is enabled by providing power to the geo-location receiver (step 70). It should be appreciated that, according to this variation of the present method, battery power in a mobile geo-tracking device is conserved by depriving a geo-location receiver of electrical power whenever a geo-location reports is not required.

FIG. 6 is a flow diagram that depicts one alternative method for enabling a feedback device. According to this variation of the present method, a feedback device comprises a wireless network interface circuit (e.g. 802.11 wireless Ethernet). Accordingly, this variation of the present method provides for enabling the wireless network interface by providing power to the wireless network interface (step 75). Again, the power is applied only when a geo-position report needs to be conveyed to a distal processing center.

FIG. 7 is a flow diagram that depicts yet another variation of the present method for enabling a feedback device. According to this variation of the present method, a feedback device comprises a cellular telephone interface circuit. Accordingly, this variation of the present method provides for enabling the feedback device by providing power to the cellular telephone interface circuit (step 80). Again, the power is applied only when a geo-position report needs to be conveyed to a distal processing center.

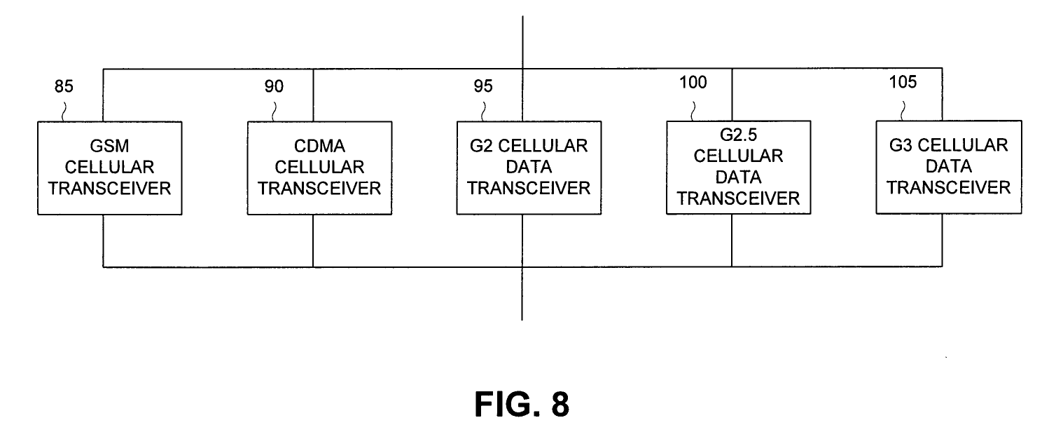

FIG. 8 is a flow diagram that depicts alternative example methods for enabling a cellular telephone interface circuit. According to one example variation of the present method, a cellular interface circuit is enabled by providing power to a GSM cellular transceiver (step 85). In yet another example variation of the present method, providing power to a cellular telephone interface circuit is accomplished by providing power to a CDMA cellular transceiver (step 90). According to yet another alternative example variation of the present method, enabling a cellular telephone interface circuit is accomplished by providing power to a G2 cellular data interface (step 95). In yet another example variation of the present method, providing power to a cellular telephone interface circuit is accomplished by providing power to a G2.5 cellular data transceiver (step 100). In yet another example variation of the present method, providing power to a cellular telephone interface circuit is accomplished by providing power to a G3 cellular data transceiver (step 105).

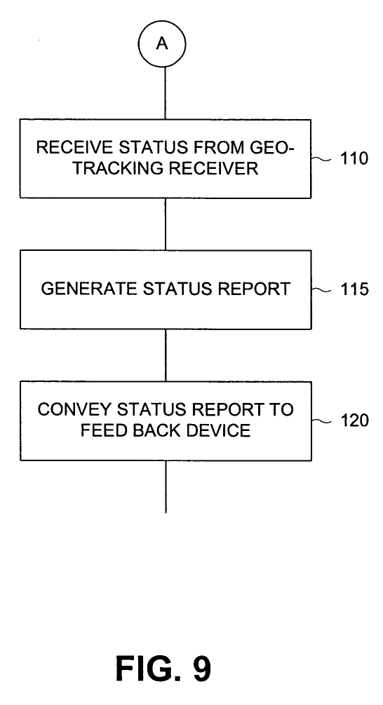

FIG. 9 is a flow diagram that depicts one alternative method for providing a geo-location report. According to this variation of the present method, a geo-location report is provided by further providing a status indication to a distal processing center. Accordingly, this variation of the present method provides for receiving a status indicator from a geo-tracking receiver included in a geo-tracking device (step 110). A status report is then generated according to the status indicator received from the geo-tracking receiver (step 115). The generated status report is then conveyed to a distal processing center by means of the feedback device (step 120). It should be appreciated that, according to yet another variation of the present method, a status indicator is received from a battery that supplies power to a geo-tracking device. In yet another variation of the present method, a status indication is received from a feedback device included in a geo-tracking device. In yet another variation of the present method, a status indicator is received from a wakeup receiver included in a geo-tracking device. In each of the afore described variations of the present method, a status report is generated according to a received status indicator and conveyed to a distal processing center by means of the feedback device.

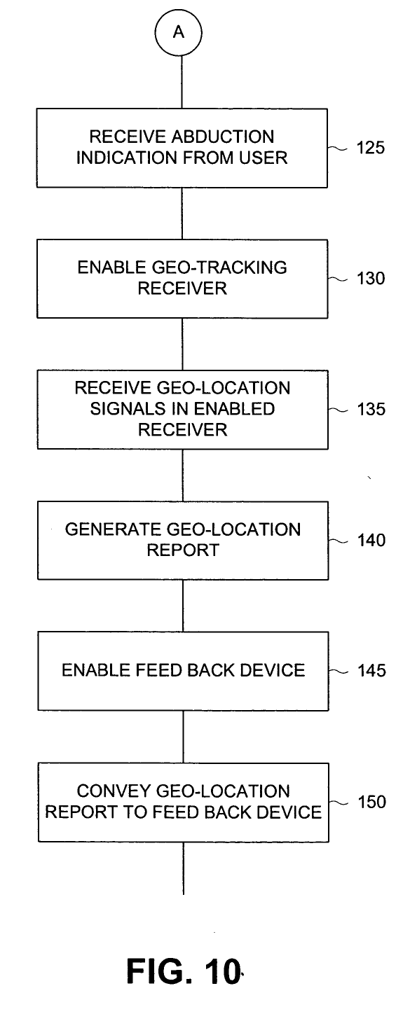

FIG. 10 is a flow diagram that depicts an alternative method for providing a geo-location report in an abduction situation. According to this variation of the present method, a geo-location report is provided to a distal processing center by further receiving an abduction indication from a user (step 125). Upon receipt of an abduction indication from a user, this example variation of the present method provides for enabling a geo-location receiver included in a geo-tracking device (step 130). Once enabled, the geo-location receiver receives geo-location signals (step 135). A geo-location report is then generated according to the received geo-location signals (step 140). Once a geo-location report is generated, a feedback device is enabled (step 145) and the geo-location report is conveyed a distal processing center using the enabled feedback device (step 150). It should be appreciated that, according to this variation of the present method, a user may provide an abduction indication by means of a “panic button”. Once the panic button is actuated, one variation of the present method provides for generating geo-location position report and conveying the geo-location report to a distal processing center using the enabled feedback device.

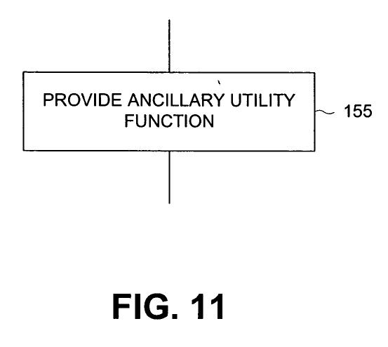

FIG. 11 is a flow diagram that depicts one alternative variation for providing a utility function in addition to a geo-location position report. It should be appreciated that a geo-location tracking device may need to be camouflaged, or otherwise concealed while it is in operation. This is to prevent an undesired disablement of the geo-location tracking device. For example, a geo-location tracking device, according to one illustrative use case, may be used to track a child. As such, it is highly desirable that the geo-location tracking device continue to operate in a surreptitious manner so that an abductor will not be encouraged to disable the device or separate the device from an abducted child. As such, concealment of a geo-location tracking device, according to this variation of the present method, is accomplished by providing an ancillary utility function (step 155). An ancillary utility fund, according to various alternative methods, provides a utility function commensurate with at least one of a shoe, a bracelet, a belt, a watch, a pendant, a button, a hat, a hair band, a backpack, a plush, a toy, a bicycle, a necklace, an article of jewelry, a helmet, an article of clothing, a pen, a notebook, a skateboard, a scooter, a rollerblade, a stroller, infant car seat, a bassinet, and a child carrier.

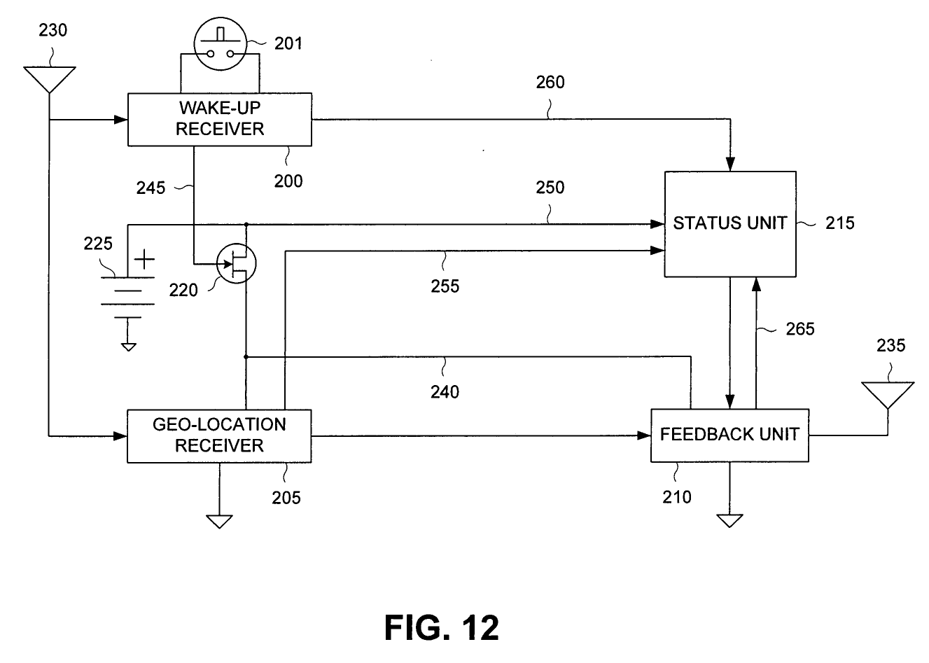

FIG. 12 is a block diagram that depicts one example embodiment of a geo-location reporting apparatus. According to this example embodiment, a geo-location reporting apparatus comprises a wakeup receiver 200, a geo-tracking receiver 205, a feedback unit 210 and an enabled unit 220. In operation, the wakeup receiver receives a wakeup signal, which is typically received by means of an antenna 230. Upon receiving a wakeup signal, the wakeup receiver 200 generates a wakeup directive, which is used to enable the geo-location receiver 205. According to one alternative embodiment, the wakeup directive is also used to enable the feedback unit 210. Once enabled, the geo-location receiver 205 receives a plurality of geo-tracking signals, typically by means of the antenna 230. It should be appreciated that, according to one alternative embodiment, the wakeup receiver 200 and the geo-location receiver 205 share a single antenna 230. In yet another alternative embodiment, the wakeup receiver 200 and the geo-location receiver 205 operate from separate antennas. It should be appreciated that a wakeup directive generated by the wakeup receiver 200 is used to control an enabled unit 220. According to one alternative embodiment, the enabled unit 220 comprises a power controller, such as a solid-state switch (e.g. a field effect transistor). The power controller 220, according to one alternative embodiment, enables power to at least one of the geo-location receiver 205 and the feedback unit 210.

The geo-location receiver 205 generates a geo-report according to geo-location signals it receives by means of the antenna 230. The geo-location report is directed to the feedback unit 210, which conveys the geo-location report to a distal processing center. It should be appreciated that the feedback unit 210 uses an antenna 235 to convey the geo-location report to the distal processing center.

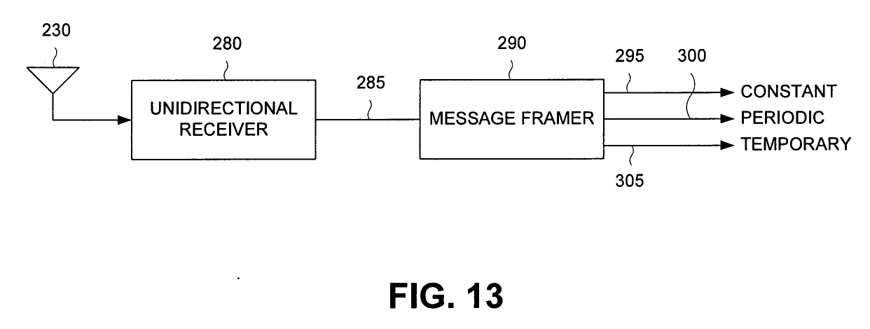

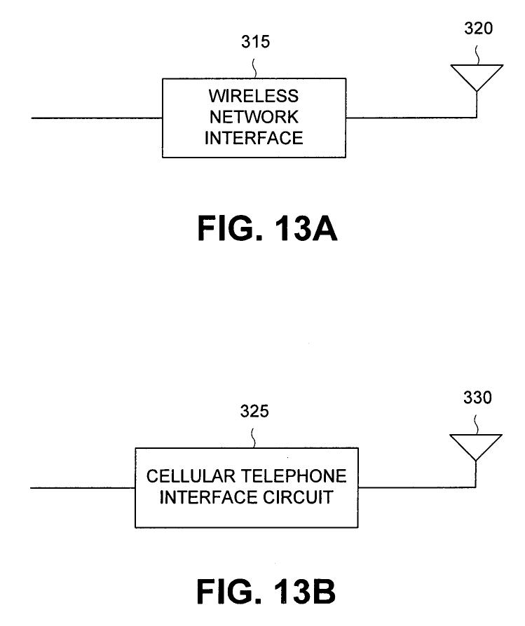

FIG. 13 is a block diagram that depicts one example embodiment of a wakeup receiver. According to this example embodiment, a wakeup receiver comprises a unidirectional receiver 280. The unidirectional receiver passively monitors for a radio frequency signal, which is received by means of the antenna 230. The output of the unidirectional receiver 280 comprises a data stream 285. The data stream is captured by a message framer 290. Message framer 290 extracts a message from the data stream 285 provided by the unidirectional receiver 280. The message framer 290 generates a wakeup directive according to an extracted message. In one alternative embodiment, the unidirectional receiver 280 comprises a direct-sampling receiver, which is typically fashioned to receive a radio frequency signal of less than 100 MHz.

The message framer 290, of one alternative example embodiment, generates one of three different types of wakeup directives. According to one alternative embodiment, the message framer 290 generates a constant-tracking directive 295. The constant-tracking directive is generated by the message framer 210 on a continuous basis. This causes the geo-location receiver 205 and the feedback unit 210 to be continuously enabled, thereby providing a constant stream of geo-location reports to a distal processing center. In yet another example embodiment, the message framer 290 generates a periodic-tracking directive 300. The periodic-tracking directive is activated for a short duration on a periodic basis. This causes the geo-location receiver 205 and the feedback unit 210 to be enabled a periodic basis, thereby causing a periodic reporting of geo-location to a distal processing center. In yet another alternative embodiment, the message framer 290 generates a temporary-tracking directive 305. The temporary-tracking directive is enabled for a short duration of time, thereby enabling the geo-location receiver 205 and the feedback unit 210 to provide some number of geo-location reports back to a distal processing center. Subsequently, the temporary-tracking directive is disabled.

FIG. 13A is a block diagram depicts one example embodiment of a feedback device. According to this example embodiment, the feedback device comprises a wireless network interface 315. The wireless network interface 315 engages in a wireless network by means of an antenna 320.

FIG. 13B is a block diagram depicts another example embodiment of a feedback device. According to this example embodiment, the feedback device comprises a cellular telephone interface circuit 325. The cellular telephone interface circuit 325 interacts with a cellular telephone system by means of an antenna 330. The cellular telephone interface circuit 325 uses the cellular telephone system in order to convey a geo-location report received from the geo-location receiver 205 to a distal processing center. According to various alternative embodiments, the cellular telephone interface circuit 325 includes at least one of a GSM cellular transceiver, a CDMA cellular transceiver, a G2 cellular data transceiver, a G2.5 cellular data transceiver and a G3 cellular data transceiver. It should be appreciated that any type of cellular telephone interface circuit can be utilized and the foregoing list is provided herein merely to further illustrate several example embodiments and is not intended to limit the scope claims appended hereto.

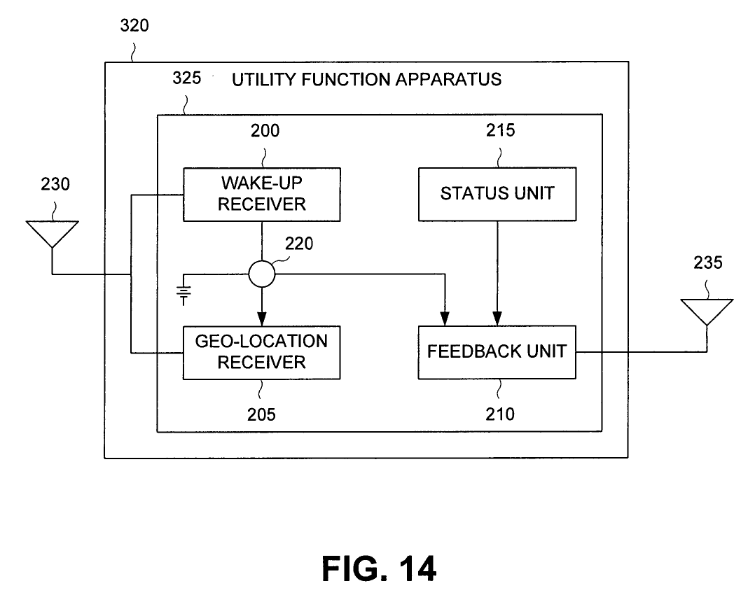

FIG. 14 is a block diagram depicts one alternative example embodiment of a geo-location reporting apparatus that includes a utility function. According to this example embodiment, a geo-location reporting apparatus 325 is integrated into a utility function apparatus 320. Accordingly, the geo-location reporting apparatus 325 includes a wake-up receiver 200, a two-location receiver 205 and a feedback unit 210. According to one alternative embodiment the geo-location reporting apparatus 325 further includes a status unit 215. The feedback unit 210 is communicatively coupled to an antenna 235. The geo-location reporting apparatus 325 is fashioned to operate in accordance of the teachings of the present method. As such, the geo-location reporting apparatus 325 further includes a power enablement unit 220, enables power from a battery to reach the geo-location receiver 205 and the feedback unit 210 according to a signal received from the wake-up receiver 200. It should be appreciated that the wake-up receiver 200 and the geo-location receiver 205, according to one alternative example by unit, receives signals by means of a receive antenna 230.

To be appreciated that the utility function apparatus 320 can take on various forms. The utility function apparatus 320 includes at least one of a shoe, a bracelet, a belt, a watch, a pendant, a button, a hat, a hair band, a backpack, a plush, a toy, a bicycle, a necklace, an article of jewelry, a helmet, an article of clothing, a pen, a notebook, a skateboard, a scooter, a rollerblade, a stroller, infant car seat, a bassinet, and a child carrier. It should be appreciated that any of the example utility function apparatus here presented not intended to limit the scope of the claims appended hereto.

While this disclosure has described several alternative methods and exemplary embodiments, it is contemplated that alternatives, modifications, permutations, and equivalents thereof will become apparent to those skilled in the art upon a reading of the specification and study of the drawings. It is therefore intended that the true spirit and scope of the appended claims include all such alternatives, modifications, permutations, and equivalents.

What is claimed is:

1. A method for providing a geo-location position report comprising:
receiving a wake-up signal for a geo-tracking device;
enabling a geo-tracking receiver according to the wake-up signal;
receiving geo-location signals in the enabled geo-tracking device;
generating a geo-location report according to the geo-location signals;
enabling a feedback device; and
conveying the geo-location report to the feedback device.

2. The method of claim 1 wherein receiving a wake-up signal comprises:
monitoring a radio frequency for a unidirectional signal;
extracting a message from the unidirectional signal; and
generating a wake-up signal according to the message.

3. The method of claim 2 wherein monitoring a radio frequency for a unidirectional signal comprises monitoring a frequency below 100 MHz for a unidirectional signal.

4. The method of claim 2 wherein extracting a message from the unidirectional signal comprises extracting at least one of a constant tracking message, a periodic-reporting message and a temporary tracking message.

5. The method of claim 1 wherein enabling the geo-tracking receiver comprises providing power to a geo-location receiver according to the wake-up signal.

6. The method of claim 1 wherein enabling a feedback device comprises providing power to a wireless network interface.

7. The method of claim 1 wherein enabling a feedback device comprises providing power to a cellular data interface.

8. The method of claim 7 wherein providing power to a cellular data interface comprises providing power to at least one of a GSM cellular transceiver, a CDMA cellular transceiver, a G2 cellular data transceiver, a G2.5 cellular data transceiver and a G3 cellular data transceiver.

9. The method of claim 1 further comprising:
receiving a status indication from within the geo-tracking device;
generating a status report according to the status indication; and
conveying the status report to the feedback device.

10. The method of claim 1 further comprising:
receiving an abduction indication from a user; and
enabling the geo-tracking receiver according to the abduction indication;
receiving geo-location signals in the enabled geo-tracking device;
generating a geo-location report according to the geo-location signals;
enabling the feedback device; and
conveying the geo-location report to the feedback device.

11. The method of claim 1 further comprising provide ancillary utility function.

12. A geo-location reporting apparatus comprising:
wakeup receiver capable of generating a wakeup signal;
geo-tracking receiver capable of generating a geo-location report according to a plurality of received geo-tracking signals;
feedback unit capable of conveying the geo-location report to a distal processing center; and
enablement unit capable of enabling at least one of the geo-tracking receiver and the feedback unit according to the wakeup signal.

13. The geo-location reporting apparatus of claim 12 wherein the wakeup receiver comprises:
unidirectional receiver capable of passively receiving a radio frequency signal; and
message framer capable of extracting a message from a received radio frequency signal and further capable of generating a wakeup signal according to an extracted message.

14. The geo-location reporting apparatus of claim 13 wherein the unidirectional receiver is capable of receiving a radio frequency of less than 100 MHz.

15. The geo-location reporting apparatus of claim 13 wherein the message framer is capable of generating at least one of a constant tracking wakeup signal, a periodic-reporting wakeup signal and a temporary tracking wakeup signal.

16. The geo-location reporting apparatus of claim 12 wherein the enablement unit comprises a power-controller capable of providing power to the geo-location receiver when the wakeup signal is active.

17. The geo-location reporting apparatus of claim 12 wherein the enablement unit comprises a power-controller capable of providing power to the feedback device when the wakeup signal is active and wherein the feedback device comprises a wireless network interface.

18. The geo-location reporting apparatus of claim 12 wherein the feedback device comprises at least one of a GSM cellular transceiver, a CDMA cellular transceiver, a G2 cellular data transceiver, a G2.5 cellular data transceiver and a G3 cellular data transceiver and wherein the enablement unit comprises a power-controller capable of providing power to the feedback device.

19. The geo-location reporting apparatus of claim 12 further comprising a status unit capable of generating a status report according to the state of at least one of a battery, the wakeup receiver, the geo-location receiver and the feedback unit and wherein the feedback unit is further capable of conveying the status report to the distal processing center.

20. The geo-location reporting apparatus of claim 12 further comprising an abduction switch and wherein the wakeup receiver if further capable of activating the wakeup signal when the abduction switch is actuated.

21. The geo-location reporting apparatus of claim 12 further comprising a utility function apparatus.

22. The method of claim 21 wherein the utility function apparatus comprises at least one of a shoe, a bracelet, a belt, a watch, a pendant, a button, a hat, a hair band, a backpack, a plush, a toy, a bicycle, a necklace, an article of jewelry, a helmet, an article of clothing, a pen, a notebook, a skateboard, a scooter, a rollerblade, a stroller, infant car seat, a bassinet, and a child carrier.
